(19) United States
(12) Patent Application Publication
(10) Pub. No.: US 2012/0061557 A1
(43) Pub. Date: Mar. 15, 2012

(54) LASER NAVIGATION MODULE

(75) Inventor: Ki Hoon Jang, Gyunggi-do (KR)

(73) Assignee: SAMSUNG ELECTRO-MECHANICS CO., LTD., Gyunggi-do (KR)

(21) Appl. No.: 12/954,779

(22) Filed: Nov. 26, 2010

(30) Foreign Application Priority Data
Sep. 9, 2010 (KR) 1020100088410

(51) Int. Cl. H01J 40/14

(52) U.S. Cl. 250/221

(57) ABSTRACT

Disclosed herein is a laser navigation module. The laser navigation system includes a light source, one or more illumination devices, and a re-reflecting layer. The light source emits laser light. The housing is configured such that a window for allowing the laser light emitted by the light source to pass therethrough, reflecting the laser light, and blocking entry of visible light is mounted and such that a transparent or translucent portion for diffusing internally diffused light to an outside is formed. The illumination devices are mounted inside the housing. The light diffusion member transfers light emitted by the illumination devices to the housing, and includes a re-reflecting layer partially formed on the side of the light diffusion member opposite the illumination devices.

### CROSS REFERENCE TO RELATED APPLICATION

This application claims the benefit of Korean Patent Application No. 10-2010-0088410, filed on Sep. 9, 2010, entitled “Laser Navigation Module,” which is hereby incorporated by reference in its entirety into this application.

### BACKGROUND OF THE INVENTION

1. Technical Field

The present invention relates to a laser navigation module.

2. Description of the Related Art

In general, personal mobile communication terminals, such as mobile phones or smart phones, include user interfaces using keypads, and these keypads include input buttons used to input information regarding numerals, characters and directions.

Furthermore, recently, with the commercialization of wireless Internet service, such as Wireless Broadband (WiBro) service, personal mobile communication terminals have come to adopt a Windows Operating System (OS) which supports a Graphical User Interface (GUI).

In response to the above-described adoption of GUI OSs for the user interfaces of personal mobile communication terminals and the demand for the development of input devices that are suitable for mobile communication terminals and convenient and simple for users to use, touch keys, joy sticks and optical pointing devices used to perform sequential input on keypads displayed on the display screens of mobile communication terminals have been developed. One such device is a laser navigation module which includes a window and a lid.

Furthermore, since such laser navigation modules are not equipped with separate illumination devices, they are problematic in that users use them in dark environments.

In greater detail, FIG. 1 is an exploded perspective view schematically showing a conventional laser navigation module, which is an input device for a mobile communication terminal. As shown in this drawing, the laser navigation module 100 includes a window 110, a housing 120, a lid 130, a control Integrated Circuit (IC) chip 140, a Printed Circuit Board (PCB) 150, and a dome switch 160.

The window 110 allows laser light emitted by a light source to pass therethrough, and blocks visible light. Furthermore, the window 110 is accommodated in the housing 120.

The lid 130 is located below the window 110, functions as a blocking unit for blocking the entry of undesirable light, and includes a stepped portion 131, a circular hole 132, and a square through portion 133. The stepped portion 131 is used to enable the lid 130 to be more tightly combined with the housing 120, the circular hole 132 is used to allow the laser light emitted by the light source to pass therethrough, and the square through portion 133 is used to allow laser light, reflected and refracted by a user's body in contact with the window 110 and then recovered, to pass therethrough.

The control IC chip 140 includes a Vertical Cavity Surface Emitting Laser (VCSEL) 141 (which is the light source of light), functions to calculate the displacement value of the laser light which is reflected and refracted on the window 110 and is then recovered, and is combined with the PCB 150. Furthermore, the dome switch 160 is placed below the PCB 150. The dome switch 160 functions to detect the pressing action of a user and to transfer a user's selection signal to a control unit (not shown) located below the dome switch 160.

Since the conventional laser navigation module is not equipped with a separate illumination device, it is inconvenient for a user to use in dark environments. Although an illumination device may be provided outside the laser navigation module, it is very difficult to mount an illumination device inside a small-sized laser navigation module, and it is impossible to uniformly diffuse light, emitted by the internal illumination device, at the desired luminance.

### SUMMARY OF THE INVENTION

Accordingly, the present invention has been made keeping in mind the above problems occurring in the prior art, and the present invention is intended to provide a laser navigation module in which an illumination device is provided in a housing, a light diffusion member for diffusing light emitted by the illumination device is included, and a re-reflecting layer is disposed beneath the light diffusion member and etched portions are formed in the light diffusion member, so that light can be uniformly diffused, with the result that users can use the laser navigation module in dark environments.

According to the present invention, there is provided a laser navigation module, including a light source for emitting laser light; a housing configured such that a window for allowing the laser light emitted by the light source to pass therethrough, reflecting the laser light, and blocking entry of visible light is mounted and such that a transparent or translucent portion for diffusing internally diffused light to an outside is formed; one or more illumination devices mounted inside the housing; and a light diffusion member configured to transfer light emitted by the illumination devices to the housing and to include a re-reflecting layer partially formed on the side of the light diffusion member opposite the illumination devices.

The light diffusion member may be configured such that a through portion configured to allow the light emitted by the light source to pass therethrough and one or more protrusions formed to correspond to the illumination devices and configured to change directions of the light emitted by the illumination devices are provided, and the re-reflecting layer is formed in a region other than that occupied by the protrusions.

The re-reflecting layer may be formed of an Ag-coated mirror tape.

The light diffusion member may be partially provided with etched portions along the edge of a top of the light diffusion member.

The etched portions may be formed in regions where the light emitted by the illumination devices is not diffused upwards but reflected.

The laser navigation module may further include a lid located below the window, and configured to function as a blocking part for blocking undesirable light and to include a circular hole and a square through portion; a control Integrated Circuit (IC) chip configured to include a Vertical Cavity Surface Emitting Laser (VCSEL) and to calculate a displacement value of laser light reflected and refracted on the window and then recovered; a PCB configured such that the control IC chip is combined therewith; and a dome switch provided below the PCB.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view schematically showing a conventional laser navigation module;

FIG. 2 is a schematic sectional view showing a laser navigation module according to the present invention;

FIG. 3 is a perspective view schematically showing the light diffusion member of the laser navigation module according to a first embodiment of the present invention;

FIG. 4 is a plan view schematically showing the light diffusion member of the laser navigation module according to a second embodiment of the present invention; and

FIG. 5 is photos schematically showing the states of the diffusion of light before and after etched portions are formed in the light diffusion member according to the present invention.

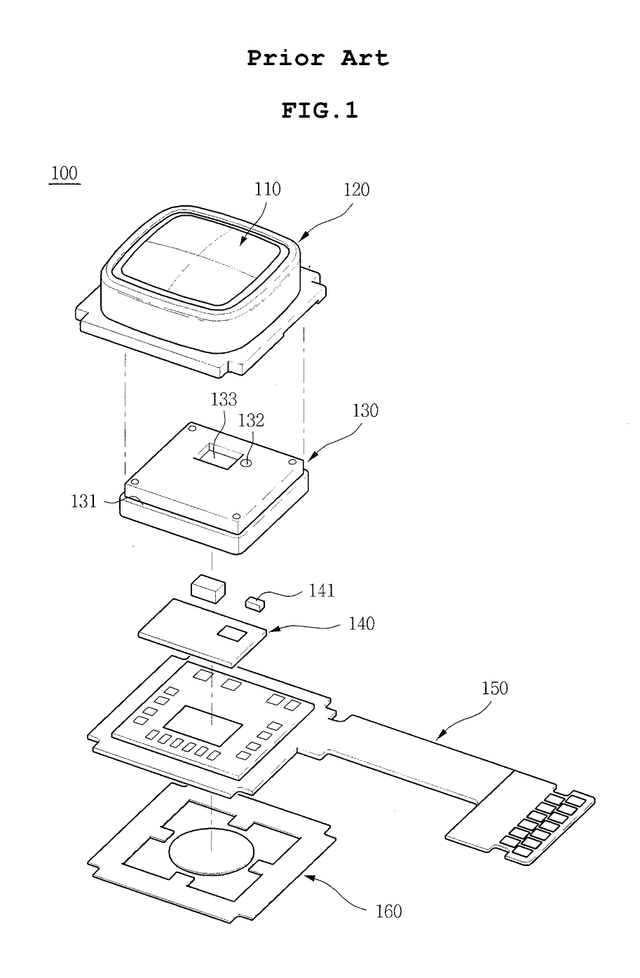

### DESCRIPTION OF THE PREFERRED EMBODIMENTS

It should be noted that the same reference numerals are used as much as possible throughout the different drawings to designate the same or similar components. In the following description, detailed descriptions of well-known functions or configurations which may unnecessarily make the gist of the present invention obscure will be omitted from the detailed description.

Preferred embodiments of the present invention will be described in detail below with reference to the accompanying drawings.

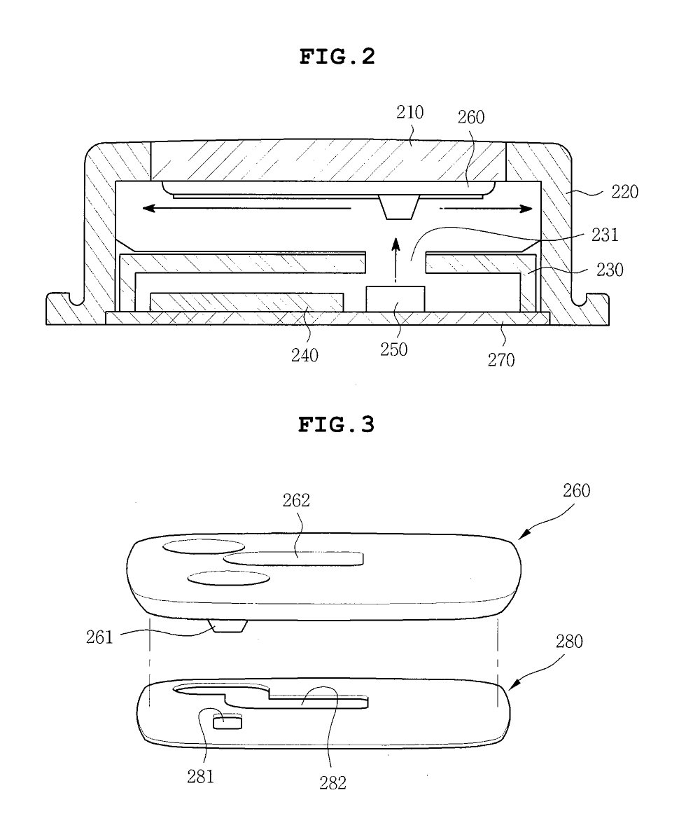

FIG. 2 is a schematic sectional view showing a laser navigation module according to the present invention. As shown in this drawing, the laser navigation module 200 includes an infrared (IR) window 210, a housing 220, a VCSEL (not shown), a lid 230, a control IC chip 240, an illumination device 250, a light diffusion member 260, a PCB 270, and a dome switch (not shown).

The laser navigation module according to the present invention is implemented by placing the PCB 270 above the dome switch (not shown) and providing the control IC chip 240, the VCSEL (not shown) and the illumination device 250 on the PCB 270 sequentially. Furthermore, the lid 230 is provided above the VCSEL and the illumination device. Furthermore, the housing 220 in which the light diffusion member 260 is disposed and the IR window 210 is mounted on the light diffusion member 260 is provided above the lid 230.

In greater detail, the lid 230 functions as a blocking part for blocking the entry of undesirable light, and is provided with a circular hole (not shown) and a square through portion for allowing laser light diffused by the VCSEL, which is a light source, to pass therethrough and a through hole 231 for allowing light diffused by the illumination device 250 to pass therethrough.

The control IC chip 240 includes the VCSEL, and calculates the displacement value of laser light which is reflected and refracted by the IR window and is then recovered. Furthermore, the VCSEL 220 is a light source for emitting laser light, and the IR window 210 functions to allow laser light to pass therethrough, to reflect the laser light emitted by the VCSEL, and to block the entry of visible light.

Furthermore, the illumination device 250 functions to diffuse light out of the housing.

Furthermore, the light diffusion member 260 is provided with a protrusion 261 for changing the direction of the advance of the light emitted by the illumination device and a through portion (designated by reference numeral “262” in FIG. 3) for allowing the laser emitted by the VCSEL to pass therethrough.

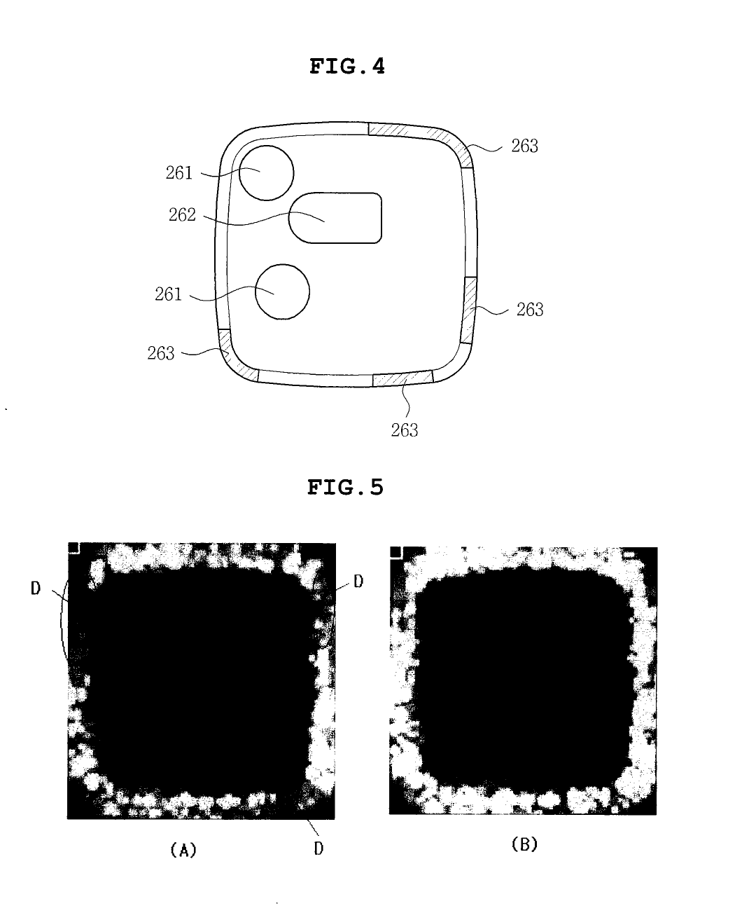

Furthermore, the illumination device 250 may include one or more illumination devices. FIG. 4, which will be described below, shows a light diffusion member in the event of two illumination devices being mounted. Furthermore, it is preferable to form the illumination devices using Light Emitting Devices (LEDs).

The housing 220 of the laser navigation module according to the present invention is formed of a transparent or translucent member so as to diffuse the light emitted by the illumination device to the outside.

FIG. 3 is a perspective view schematically showing the light diffusion member of the laser navigation module according to a first embodiment of the present invention. As shown in this drawing, the light diffusion member 260 is formed to correspond to illumination devices, and is provided with protrusions 261 for changing the paths of the light emitted by the illumination devices and a through portion 262 for allowing the light emitted by the VCSEL (not shown), which is a light source, to pass therethrough. Furthermore, one or more the protrusions 261 are formed to correspond to the illumination devices. In the case where a plurality of illumination devices is provided, a plurality of protrusions corresponding to these illumination devices is formed.

Furthermore, the light diffusion member 260 is partially provided with a re-reflecting layer on the side of the light diffusion member 260 opposite the illumination devices. Furthermore, the re-reflecting layer may be an Ag-coated mirror tape 280, and may be formed using a method in which the re-reflecting layer is taped onto one surface of the light diffusion member 260. In this case, the mirror tape 280 is provided with a first hollow 281 corresponding to the protrusion 261 and a second hollow 282 corresponding to the through portion 261. FIG. 3 shows the mirror tape 280 in which, in order to more efficiently correspond to and be combined with the light diffusion member having two protrusions 26, the first hollow 281 corresponding to one of the protrusions 261 and the second hollow 282 corresponding to the other protrusion 261 and the through portion 262 have been formed. Meanwhile, the re-reflecting layer may be implemented using a variety of methods, such as a method in which a coating material is directly applied to light diffusion member 260.

FIG. 4 is a plan view schematically showing the light diffusion member of the laser navigation module according to a second embodiment of the present invention. In greater detail, this drawing is a top plan view showing the light diffusion member when illumination devices are located below the light diffusion member. The light diffusion member 360 is provided with protrusions 361 for changing the paths of light emitted by the illumination devices and a through portion 362 for allowing light emitted by the VCSEL (not shown), which is a light source, to pass therethrough. Furthermore, the protrusions 361 project toward the illumination devices, and are shown in the form of a plan view in FIG. 4. Furthermore, the light diffusion member 360 is partially provided with etched portions 363 along the edge of the top of the light diffusion member 260.

Furthermore, the two protrusions 361 are formed to correspond to the case where there are two illumination devices provided. The number of protrusions 361 may vary depending on the number of illumination devices, and the locations of the protrusions 361 may vary depending on the optimum design of the laser navigation module.

The etched portions 363 are formed in a dead zone in which light emitted by the illumination devices is reflected and refracted by the protrusions 361 and is not diffused upwards by the light diffusion member 360, so that the light emitted by the illumination devices can be uniformly diffused by the light diffusion member 360. In greater detail, the light reflected and refracted upwards by the protrusions inside the light diffusion member is not diffused to the outside but reflected at points having large refraction angles. Here, in the case where the etched portions are formed at reflecting points, the light is not reflected but diffused upwards.

As a result, it is preferable to form the etched portions in regions where the light emitted by the illumination devices is not diffused upwards but reflected, and the etched portions may be implemented using one of various methods, such as etching based on chemical processing.

FIG. 5 is photos schematically showing the states of the diffusion of light before and after etched portions are formed in the light diffusion member according to the present invention. As shown in this drawing, FIG. 5(A) shows the state in which light is diffused before etched portions are formed in the light diffusion member, in which case a dead zone D in which light is diffused is generated. Here, in the case where etched portions are formed in the dead zone D, the dead zone D is eliminated and the light emitted by the illumination devices is uniformly diffused, as illustrated in FIG. 5(B).

The present invention has the advantage of providing a laser navigation module in which an illumination device is provided in a housing, a light diffusion member for diffusing light emitted by the illumination device is included, and a re-reflecting layer is disposed beneath the light diffusion member and etched portions are formed in the light diffusion member, so that light can be uniformly diffused, with the result that users can use the laser navigation module in dark environments.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A laser navigation module, comprising:
a light source for emitting laser light;
a housing configured such that a window for allowing the laser light emitted by the light source to pass therethrough, reflecting the laser light, and blocking entry of visible light is mounted and such that a transparent or translucent portion for diffusing internally diffused light to an outside is formed;
illumination devices mounted inside the housing; and
a light diffusion member configured to transfer light emitted by the illumination devices to the housing and to include a re-reflecting layer partially formed on a side of the light diffusion member opposite the illumination devices.

2. The laser navigation module as set forth in claim 1, wherein the light diffusion member is configured such that a through portion configured to allow the light emitted by the light source to pass therethrough and protrusions formed to correspond to the illumination devices and configured to change directions of the light emitted by the illumination devices are provided, and wherein the re-reflecting layer is formed in a region other than that occupied by the protrusions.

3. The laser navigation module as set forth in claim 1, wherein the re-reflecting layer is formed of an Ag-coated mirror tape.

4. The laser navigation module as set forth in claim 1, wherein the light diffusion member is partially provided with etched portions along an edge of a top of the light diffusion member.

5. The laser navigation module as set forth in claim 4, wherein the etched portions are formed in regions where the light emitted by the illumination devices is not diffused upwards but reflected.

6. The laser navigation module as set forth in claim 1, further comprising:
a lid located below the window, and configured to function as a blocking part for blocking undesirable light and to include a circular hole and a square through portion;
a control Integrated Circuit (IC) chip configured to include a Vertical Cavity Surface Emitting Laser (VCSEL) and to calculate a displacement value of laser light reflected and refracted on the window and then recovered;
a PCB configured such that the control IC chip is combined therewith; and
a dome switch provided below the PCB.
